(19) United States
(12) Patent Application Publication
(10) Pub. No.: US 2024/0284539 A1
(43) Pub. Date: Aug. 22, 2024

(54) TECHNOLOGIES FOR UNIFIED TRANSMISSION CONFIGURATION INDICATOR STATE FOR MULTIPLE TRANSMIT-RECEIVE POINT OPERATION

(71) Applicant: Apple Inc., Cupertino, CA (US)

(72) Inventors: Haitong Sun, Saratoga, CA (US); Ankit Bhamri, Haar (DE); Chunxuan Ye, San Diego, CA (US); Dawei Zhang, Saratoga, CA (US); Hong He, San Jose, CA (US); Wei Zeng, Saratoga, CA (US)

(73) Assignee: Apple Inc., Cupertino, CA (US)

(21) Appl. No.: 18/414,386

(22) Filed: Jan. 16, 2024

Related U.S. Application Data
(60) Provisional application No. 63/446,288, filed on Feb. 16, 2023.

(51) Int. Cl. H04W 76/20; H04L 5/00; H04W 72/1268; H04W 72/231

(52) U.S. Cl. CPC H04W 76/20; H04L 5/0051; H04W 72/1268; H04W 72/231

(57) ABSTRACT

The present application relates to devices and components including apparatus, systems, and methods for unified transmission configuration indicator state for multiple-transmit-receive point operation in wireless networks.

### CROSS-REFERENCE TO RELATED APPLICATION

This application claims the benefit of U.S. Provisional Patent Application No. 63/446,288, filed on Feb. 16, 2023, the contents of which are incorporated herein by reference in its entirety for all purposes.

### TECHNICAL FIELD

This application relates generally to communication networks and, in particular, to technologies for configuring and using unified transmission configuration indicator (TCI) states for multiple transmit-receive point (mTRP) operation in wireless networks.

### BACKGROUND

Third Generation Partnership Project (3GPP) Technical Specifications (TSs) provide details of radio interface protocols to facilitate communication over wireless networks. These TSs define mTRP operation in which a serving cell communicates with a user equipment (UE) using two or more transmit-receive points (TRPs). This may improve coverage, reliability, or data rates. Further improvements in mTRP operation is desired.

### BRIEF DESCRIPTION OF THE DRAWINGS

FIG. 1 illustrates a network environment in accordance with some embodiments.

FIG. 2 illustrates configurations in accordance with some embodiments.

FIG. 3 illustrates an operating mode table in accordance with some embodiments.

FIG. 4 illustrates a radio resource control (RRC) configuration in accordance with some embodiments.

FIG. 5 illustrates a media access control (MAC) control element (CE) in accordance with some embodiments.

FIG. 6 illustrates an operating mode table in accordance with some embodiments.

FIG. 7 illustrates resource pools in accordance with some embodiments.

FIG. 8 illustrates another MAC CE in accordance with some embodiments.

FIG. 9 illustrates another MAC CE in accordance with some embodiments.

FIG. 10 illustrates a power control set configuration in accordance with some embodiments.

FIG. 11 illustrates a resource configuration in accordance with some embodiments.

FIG. 12 illustrates another MAC CE in accordance with some embodiments

FIG. 13 illustrates an operational flow/algorithmic structure in accordance with some embodiments.

FIG. 14 illustrates another operational flow/algorithmic structure in accordance with some embodiments.

FIG. 15 illustrates another operational flow/algorithmic structure in accordance with some embodiments.

FIG. 16 illustrates another operational flow/algorithmic structure in accordance with some embodiments.

FIG. 17 illustrates a user equipment in accordance with some embodiments.

FIG. 18 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A.” for example, it could be “based solely on A” or it could be “based in part on A.”

The following is a glossary of terms that may be used in this disclosure.

The term “circuitry.” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations: or recording, storing, or transferring digital data. The term “processor circuitry” may refer an application processor: baseband processor: a central processing unit (CPU): a graphics processing unit: a single-core processor: a dual-core processor: a triple-core processor: a quad-core processor: or any other device capable of executing or otherwise operating computer-executable instructions, such as program code: software modules: or functional processes.

The term “interface circuitry” as used herein refers to, is part of, or includes circuitry that enables the exchange of information between two or more components or devices. The term “interface circuitry” may refer to one or more hardware interfaces: for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The terms “multi,” “multiple,” “plurality,” and the like as used herein refer to more than one item, instance, or event.

The term “channel” as used herein refers to any transmission medium, either tangible or intangible, which is used to communicate data or a data stream. The term “channel” may be synonymous with or equivalent to “communications channel,” “data communications channel.” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

3GPP TSs describe operations that rely on transmission configuration indicator (TCI) states to facilitate communications. A TCI state may define a quasi-co-location (QCL) relationship between a source and a target. The source and target may be reference signals such as, for example, a synchronization signal block (SSB), channel state information-reference signal (CSI-RS) (for beam management or channel quality indicator (CQI) measurement), or a demodulation reference signal (DMRS). Channel properties (for example, spatial, time, or frequency domain properties) determined for the source may be inferred with respect to the target. Different QCL types indicate different channel properties may be inferred. For example, QCL Type A corresponds to Doppler shift, Doppler Spread, average delay, and delay spread: QCL Type B corresponds to Doppler shift and Doppler spread: QCL Type C corresponds to Doppler shift and average delay; and QCL Type D corresponds to a spatial Rx parameter.

3GPP Release 17 (R17) introduced a unified TCI framework for single TRP operation. The unified TCI state may refer to a TCI state that applies to multiple downlink or uplink channels. For example, a unified downlink (DL) TCI state may be applied to both a downlink data channel (e.g., a physical downlink shared channel (PDSCH)) and a downlink control channel (e.g., a physical downlink control channel (PDCCH), while a unified uplink (UL) TCI state may be applied to both an uplink data channel (e.g., a PUSCH) and an uplink control channel (e.g., PUCCH). The R17 unified TCI state supports two modes. In a first mode, a joint unified TCI state is applicable to both uplink and downlink channels. In a second mode, a DL TCI state is used for downlink channels and a separate UL TCI state is used for uplink channels.

To support the two modes of R17, RRC signaling may be used to configure a UE with a pool of unified TCI states by signaling one or two lists. If only one list is used to configure the pool, the list will be a DL-or-joint-TCI-state list (dl-OrJoint-TCIStateList) having TCI states that will be used as joint unified TCI states. If two lists are used to configure the pool, the first list (dl-OrJoint-TCIStateList) will provide unified DL TCI states and a second list, UL TCI state list (ul-TCI-StateList), will provide unified UL TCI states.

In the R17 unified TCI framework, the TCI states of a configured pool may be indicated/activated in one of two ways. In a first way, a MAC control element (CE) is used to indicate either a joint unified TCI state of the configured pool, or to indicate one unified DL TCI state and one unified DL TCI state. In a second way, the MAC CE may activate a plurality of joint unified TCI states or a plurality of sets of unified UL/DL TCI states. Subsequently, DCI may be used to indicate one of the activated TCI/TCI sets that is to be used.

With respect to mTRP operation in NR networks, 3GPP Release 16 (R16) defined: multi-DCI mTRP in which DCI from two different TRPs independently scheduled PDSCH/PUSCH for respective TRPs; and single-DCI mTRP with respect to PDSCH. The single-DCI would schedule the PDSCH from different TRPs using spatial division multiplexing (SDM), frequency division multiplexing (FDM) (scheme A/B), or time division multiplexing (TDM) (scheme A/B(inter-slot)).

3GPP R17 introduced mTRP for PDCCH transmissions. Some of these aspects included PDCCH repetition via search space linkage and single frequency network (SFN)-PDCCH (scheme A/B).

3GPP R17 also introduced mTRP for PDSCH transmissions with SFN-PDSCH (scheme A/B).

3GPP R17 also introduced mTRP for PUSCH/PUCCH. Some of these aspects include PUSCH TDM repetition and PUCCH TDM repetition.

Embodiments of the present disclosure describe extensions to R17 unified TCI framework to enable single-DCI mTRP uplink operation. This may be done with respect to PUSCH, PUCCH, or SRS transmissions.

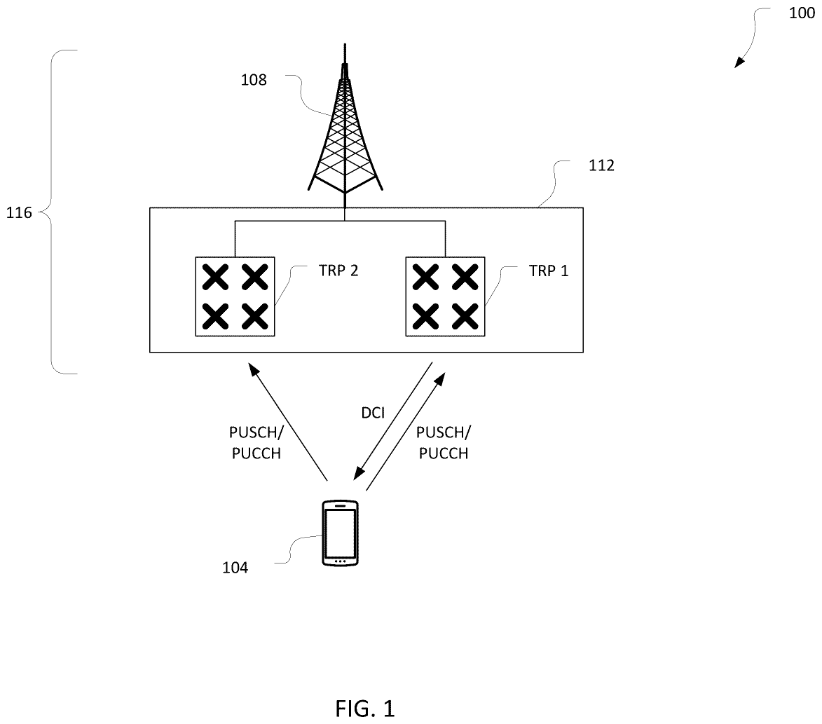

FIG. 1 illustrates a network environment 100 in accordance with some embodiments. The network environment 100 may include a UE 104 and a base station 108. The base station 108 may be coupled with a plurality of TRPs 112 to provide one or more wireless access cells through which the UE 104 may communicate. As shown, the base station 108 may be coupled with two TRPs 112, e.g., TRP 1 and TRP 2. The base station 108 may use the TRPs 112 to provide geographically distributed points of transmission/reception to increase cell coverage and spatial diversity. Each of the TRPs may include a single TRP or a group of TRPs that are generally controlled as a single TRP.

While FIG. 1 illustrates the base station 108 coupled with the two TRPs directly, in other embodiments, more than one base station may be coupled with the two TRPs and the base stations may communicate with one other over a backhaul link to coordinate communications with the UE 104. The base station 108 and TRPs 112 may be collectively referred to as an access node 116.

The access node 116 may provide an air interface compatible with 3GPP technical specifications, such as those that define Fifth Generation (5G) new radio (NR) or later system standards. Depending on the technology, the base station 108 may be referred to as an eNB, gNB, an ng-NB, etc. The access node 116 may provide the UE 104 access to other networks, for example, a core network, a data network, etc.

The access node 116 may control the uplink and downlink operation through the physical (PHY) layer and media access control (MAC) layer. The configuration information may be provided to the UE 104 by the RRC layer.

In some embodiments, the access node 116 may perform single-DCI mTRP operation in which a single DCI is used to schedule uplink or downlink transmissions with respect to more than one TRP. For example, as shown, TRP 1 may send DCI to the UE 104 that schedules uplink channel transmissions to both the TRP 1 and the TRP 2. The uplink channel transmissions may include PUSCH or PUCCH transmissions.

Embodiments of the present disclosure describe aspects that provide for two unified TCI states to be activated/indicated for single-DCI mTRP operation with respect to uplink transmissions including PUSCH, PUCCH, and SRS transmissions.

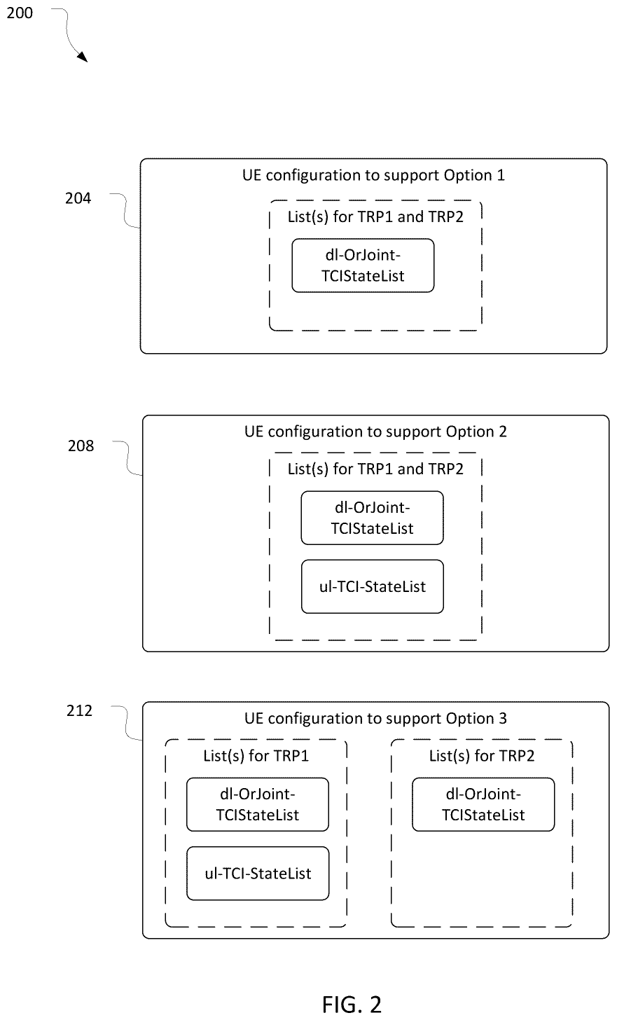

FIG. 2 illustrates configurations 200 to facilitate a first PUSCH aspect of the present disclosure applicable to PUSCH transmissions when two unified TCI states are activated/indicated for single-DCI mTRP operation. The first PUSCH aspect may be done based on one or more of the following options.

In a first option, two joint unified TCI states may be activated/indicated. Configuration 204, which may be used to support the first option, comprises one list (e.g., dl-OrJoint-TCIStateList) that is provided to the UE 104 through RRC signaling. This list may configure a TCI state pool with a plurality of joint unified TCI states. Further signaling, either MAC-based indication or MAC+DCI-based indication may be used to indicate two joint unified TCI states from the configured pool. The UE 104 may use a first joint unified TCI state of the two indicated joint unified TCI states for a first PUSCH transmission to a first TRP (e.g., TRP 1) and may use a second joint unified TCI state of the two indicated joint unified TCI states for a second PUSCH transmission to the second TRP (e.g., TRP 2).

In a second option of the first PUSCH aspect, two separate unified UL TCI states may be activated/indicated. Configuration 208, which may be used to support the second option, comprises two lists (e.g., dl-OrJoint-TCIStateList and ul-TCI-StateList) that are provided to the UE 104 through RRC signaling. These lists may configure a TCI state pool with a plurality of UL/DL unified TCI states. Further signaling, either MAC-based indication or MAC+DCI-based indication may be used to indicate two unified UL TCI states from the configured pool. The UE 104 may use a first unified UL TCI state of the two indicated unified UL TCI states for a first PUSCH transmission to a first TRP (e.g., TRP 1) and may use a second unified UL TCI state of the two indicated unified UL TCI states for a second PUSCH transmission to the second TRP (e.g., TRP 2).

In a third option of the first PUSCH aspect, one unified UL TCI state and one joint TCI state may be activated/indicated. Configuration 212, which may be used to support the third option, comprises lists (e.g., dl-OrJoint-TCIStateList and ul-TCI-StateList) that are provided to the UE 104 through RRC signaling for TRP 1 and one list (e.g., dl-OrJoint-TCIStateList) that may be provided to the UE through RRC signaling for TRP 2. Thus, in this embodiment, two TCI state pools are configured at the UE 104. The first TCI state pool may include a plurality of unified UL/DL TCI states for TRP 1, while the second TCI state pool may include a plurality of joint unified TCI states for TRP 2. Further signaling, either MAC-based indication or MAC+DCI-based indication may be used to indicate one unified UL TCI state from the first pool and one joint unified TCI state from the second pool. The UE 104 may use the unified UL TCI state for a first PUSCH transmission to TRP 1 and may use the joint unified TCI state for a second PUSCH transmission to TRP 2.

The first/second PUSCH transmissions described with respect to the first aspect, and herein in general, may include the same content or different content. Using the separate TCI states (either joint unified TCI states, unified UL TCI states, or a combination of the two) may allow the first/second PUSCH transmissions to be transmitted using beams directed to the first/second TRPs, respectively.

A second PUSCH aspect of the present disclosure is applicable to PUSCH transmissions when two unified TCI states are activated/indicated for single-DCI mTRP UL operation. These embodiments may correspond to dynamic grant (DG) PUSCH transmissions that are scheduled by DCI such as, for example, DCI format 0_1 or DCI format 0_2.

In some embodiments, the access node 106 may provide control signaling to the UE 104 to toggle the UE 104 between various operating modes. The operating modes may include different combinations of single TRP UL operation and mTRP UL operation and, with respect to the mTRP operation, different mappings of the two unified TCI states to the two TRPs. In some embodiments, the control signaling may include RRC signaling or a MAC CE and may include a mode indicator to indicate the operating mode in which the UE 104 is to operate.

In some embodiments, the UE 104 may toggle between up to four operating modes. These operating modes may be follows.

In a first operating mode, the UE 104 may perform single-TRP UL operation using a first unified TCI state of two indicated unified TCI states. The first unified TCI state may correspond to TRP 1, for example.

In a second operating mode, the UE 104 may perform single-TRP UL operation using a second unified TCI state of the two indicated unified TCI states. The second unified TCI state may correspond to TRP 2, for example.

In a third operating mode, the UE 104 may perform an mTRP UL operation using both the first unified TCI state and the second unified TCI state, with the transmission associated with the first unified TCI state preceding or overlapping with the transmission associated with the second unified TCI state. Thus, with this mode, the UE 104 may transmit a first PUSCH transmission to TRP 1 with the first unified TCI state and then transmit a second PUSCH transmission to TRP 2 with the second unified TCI state.

In a fourth operating mode, the UE 104 may perform an mTRP UL operation using both the first unified TCI state and the second unified TCI state, with the transmission associated with the second unified TCI state preceding or overlapping with the transmission associated with the first unified TCI state. Thus, with this mode, the UE 104 may first transmit a first PUSCH transmission to TRP 2 with the second unified TCI state and then transmit a second PUSCH transmission to TRP 1 with the first unified TCI state.

Providing the ability to control the UE 104 in a manner to toggle through these operating modes may allow the network to more efficiently manage network resources. For example, if the network determines that transmissions to one of the TRPs is not desired due to, for example, a reduction in a channel quality associated with that TRP, the network may cause the UE 104 to fallback to single-TRP UL operation (even for communications that are otherwise scheduled as mTRP UL communications).

A third PUSCH aspect of the present disclosure is applicable to PUSCH transmissions when two unified TCI states are activated/indicated for single-DCI mTRP UL operation. Similar to the second aspect, these embodiments may correspond to DG PUSCH transmissions that are scheduled by DCI such as, for example, DCI format 0_1 or DCI format 0_2 and may include toggling the UE 104 between a number of operating states. However, in the third aspect, the access node 116 may use DCI to provide the mode indicator to indicate the operating mode in which the UE 104 is to operate. The DCI may be scheduling DCI (e.g., the DCI that schedules the DG PUSCH transmission) or non-scheduling DCI.

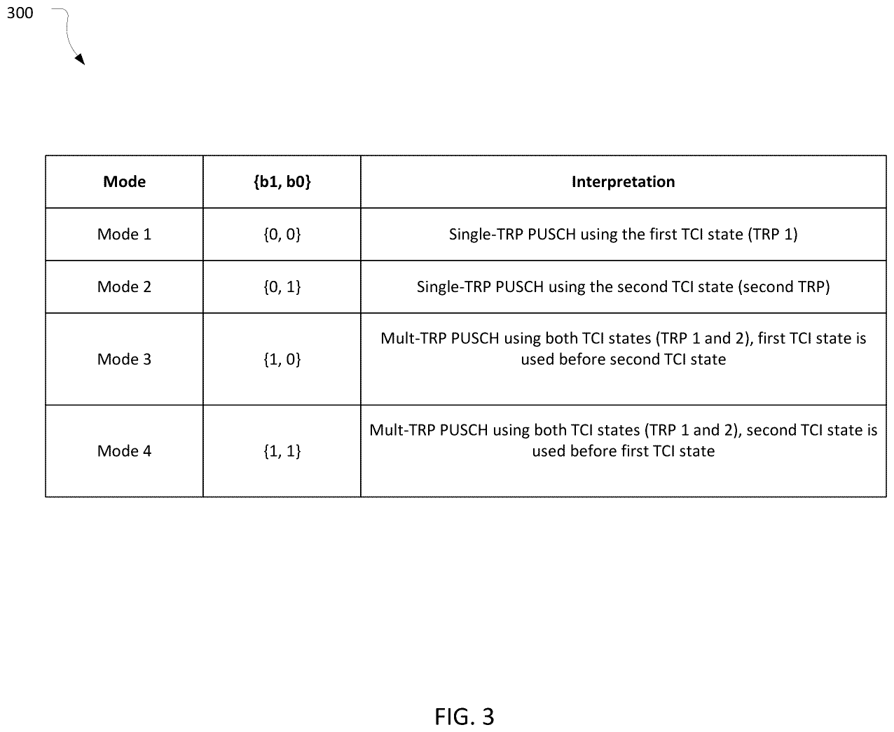

In some embodiments, the mode indicator may include two bits, e.g., {b1, b0}. The two-bit mode indicator may be interpreted based on the operating mode table 300 of FIG. 3 in accordance with some embodiments.

The mode indicator may include a value of {0, 0} to indicate the UE 104 is to operate in mode 1. In mode 1, the UE 104 may use single-TRP operation to transmit a PUSCH transmission using a first TCI state. The first TCI state may correspond to TRP 1.

The mode indicator may include a value of {0, 1} to indicate the UE 104 is to operate in mode 2. In mode 2, the UE 104 may use single-TRP operation to transmit a PUSCH transmission using a second TCI state. The second TCI state may correspond to TRP 2.

The mode indicator may include a value of {1, 0} to indicate the UE 104 is to operate in mode 3. In mode 3, the UE 104 may use mTRP operation to transmit PUSCH transmissions using both the first unified TCI state and the second unified TCI state, with the transmission associated with the first unified TCI state preceding or overlapping with the transmission associated with the second unified TCI state. Thus, in mode 3, the UE 104 may transmit a first PUSCH transmission to TRP 1 with the first unified TCI state and then transmit a second PUSCH transmission to TRP 2 with the second unified TCI state.

In some embodiments, mode 3 may be used for a single-DCI mTRP PUSCH repetition scheme such as, e.g., described in section 6.1.2 of 3GPP TS 38.214 v17.4.0 (2022-12). Thus, the second PUSCH transmission to the TRP 2 will be a repetition of the first PUSCH transmission transmitted to the TRP 1.

The mode indicator may include a value of {1, 1} to indicate the UE 104 is to operate in mode 4. In mode 4, the UE 104 may use mTRP operation to transmit PUSCH transmissions using both the first unified TCI state and the second unified TCI state, with the transmission associated with the second unified TCI state preceding or overlapping with the transmission associated with the first unified TCI state. Thus, in mode 4, the UE 104 may transmit a first PUSCH transmission to TRP 2 with the second unified TCI state and then transmit a second PUSCH transmission to TRP 1 with the first unified TCI state.

In some embodiments, mode 4 may be used for a single-DCI mTRP PUSCH repetition scheme such as, e.g., described in section 6.1.2 of 3GPP TS 38.214. Thus, the second PUSCH transmission to TRP 1 will be a repetition of the first PUSCH transmission transmitted to the TRP 2.

In other embodiments, the specific bit-value combinations associated with the various operating modes may be changed.

In some embodiments, the mode indicator may be associated with a validity period in which the UE 104 is to operate according to the designated mode. For example, if the DCI is scheduling DCI to schedule the PUSCH transmission(s), the validity period may only extend to the transmission of the scheduled PUSCH transmission(s). For another example, the mode indicator may be valid until the UE 104 receives another mode indicator in a subsequent DCI (or other control signaling). In still another example, the mode indicator may be valid for a predetermined period of time. For example, the UE 104 may start a timer upon receiving a mode indicator. The value of the timer may be predetermined or configured by the network. After the timer expires, the UE 104 may transition back to a default operating mode, e.g., mode 3.

In some embodiments, the mode indicator may be two bits in a new DCI field. In other embodiments, an existing field may be used with an updated interpretation. For example, the two-bits of the mode indicator may be in an SRS resource set indicator field or an SRS resource indicator field. RRC signaling from the network may be used to configure these fields to be used as the mode indicator.

A fourth PUSCH aspect of the present disclosure is applicable to configured grant (CG) PUSCH transmissions when two unified TCI states are activated/indicated for single-DCI mTRP UL operation. In this aspect, the mode indicator may be provided to the UE 104 through an RRC configuration associated with the configured grant.

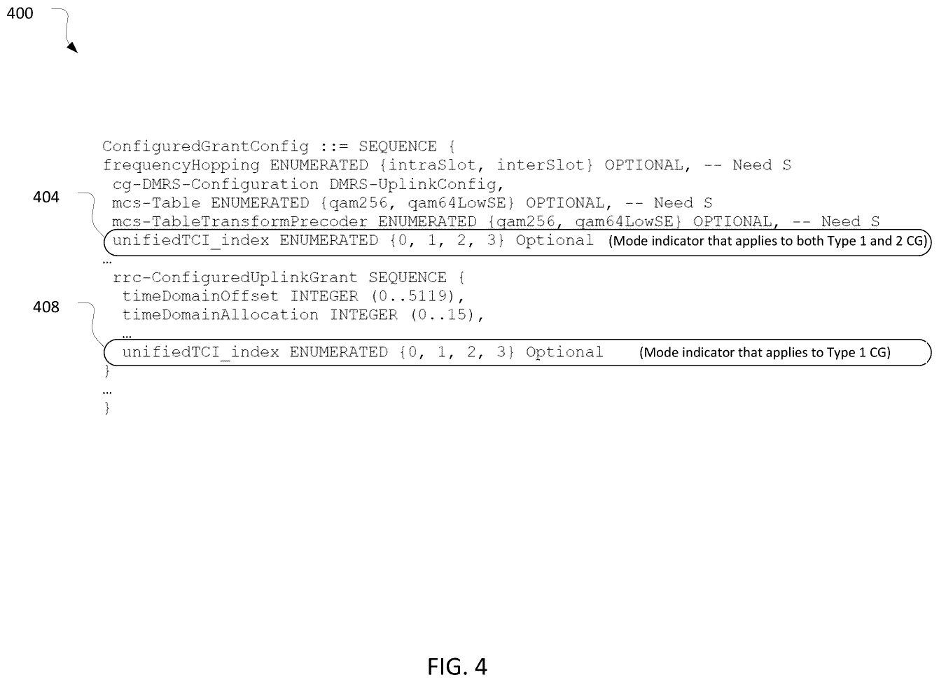

FIG. 4 illustrate RRC configuration 400 in accordance with some embodiments. In some embodiments, the mode indicator may be located in a configured grant configuration (ConfiguredGrantConfig) IE, shown as “unified TCI_index 404” in FIG. 4. Additionally/alternatively, the mode indicator may be located in an RRC configured uplink grant (rrc-ConfiguredUplinkGrant) IE, shown as “unified TCI_index 408” in FIG. 4. The unified TCI_index 404 or 408 may have two bits that are interpreted similar to that described above with respect to operating mode table 300. Placing the mode indicator in the ConfiguredGrantConfig IE or rre-ConfiguredUplinkGrant IE may be related, at least in part, to whether Type 1 or Type 2 configured grant is used.

Type 1 configured grants may be fully configured using RRC signaling without requiring DCI. Once the Type 1 configured grant is configured, the UE 104 may use the grant. Type 2 configured grants may use a combination of RRC signaling to configure the resources, and DCI to activate them for use by the UE 104.

Placing the mode indicator in the ConfiguredGrantConfig IE, e.g., unified TCI_index 404, may configure the operating mode for both CG type 1 and CG type 2. This may place the UE 104 in the designated operating mode for the entirety of the configured grant, e.g., until a new configured grant is configured.

Placing the mode indicator in the rre-ConfiguredUplinkGrant IE, e.g., unified TCI_index 408, may configure the operating mode for Type 1 configured grant while the operating mode for Type 2 is indicated by DCI. In this embodiment, the DCI that activates the Type 2 CG resources may be used to dynamically select which operating mode is to be used by the UE 104 during the activation period. This may be done by some specific field in DCI to indicate the desired operating mode for the UE 104 in a given activation period. This may allow the network to have more flexibility in updating the operating mode.

A fifth PUSCH aspect of the present disclosure is also applicable to CG PUSCH transmissions when two unified TCI states are activated/indicated for single-DCI mTRP UL operation. In this aspect, the mode indicator may be provided to the UE 104 through a MAC CE.

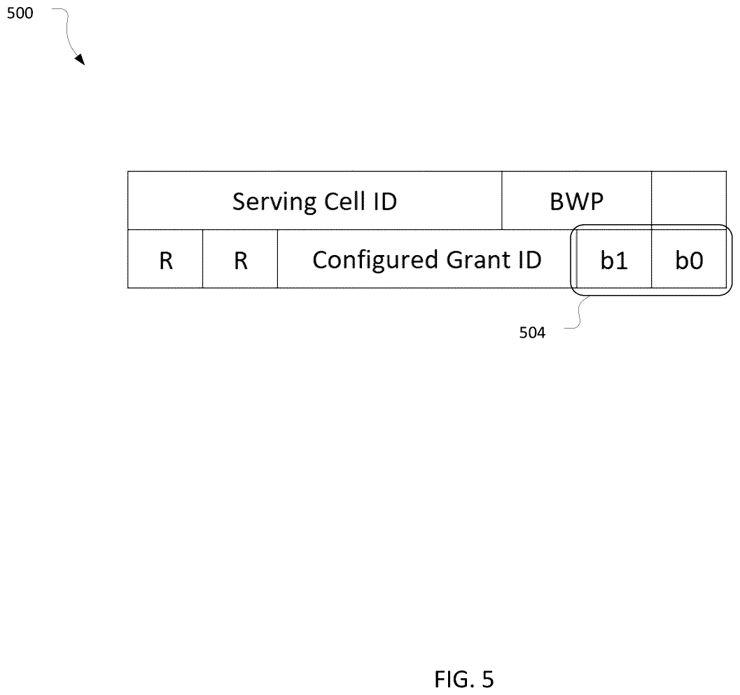

FIG. 5 illustrate a MAC CE 500 in accordance with some embodiments. The MAC CE 500, in a first octet, a serving cell identifier (ID) and a BWP ID. The serving cell ID includes, e.g., five bits to indicate an identity of the serving cell for which the MAC CE 500 applies. The BWP ID includes, e.g., two bits to indicate the BWP for which the MAC CE 500 applies.

In a second octet, the MAC CE 500 may include a configured grant ID that provides an index of the configured grant for which the MAC CE 500 applies. The second octet may also include a mode indicator 504. The mode indicator 504 may include two bits that may be interpreted similar to that described above with respect to operating mode table 300.

A sixth PUSCH aspect of the present disclosure is applicable to Type 2 CG PUSCH transmissions when two unified TCI states are activated/indicated for single-DCI mTRP UL operation. In these embodiments, the DCI that is used to activate CG resources may include the mode indicator. The DCI may be, for example, DCI format 0_1 or DCI format 1_1 with cyclic redundancy check (CRC) bits scrambled by a configured scheduling radio network temporary identifier (CS-RNTI). The mode indicator may be a two-bit indicator that may be interpreted similar to that described above with respect to operating mode table 300 and may otherwise be similar to the second and third PUSCH aspects described with respect to DG PUSCH.

Three PUCCH aspects will be described as follows.

A first PUCCH aspect of the present disclosure is applicable to PUCCH transmissions when two unified TCI states are activated/indicated for mTRP UL operation. In these embodiments, the access node 116 may use RRC to provide the mode indicator to indicate the operating mode in which the UE 104 is to operate. This may be done based on one or more of the following two options.

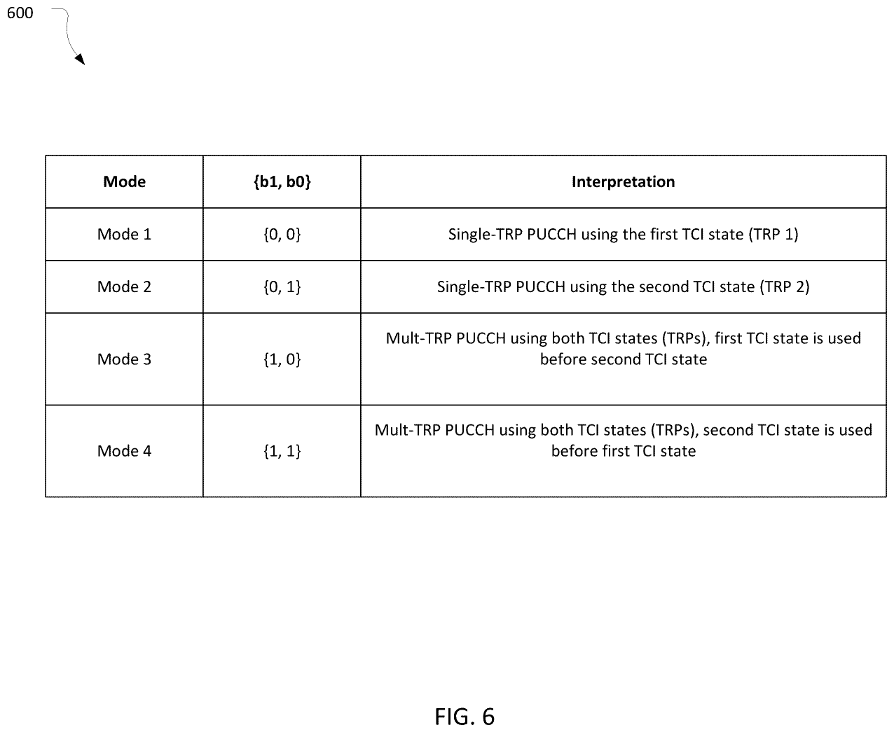

In a first option, the access node 116 may provide a mode indicator for each PUCCH-resource. For example, the access node 116 may provide the UE 104 with a PUCCH-resource configuration that includes two bits, e.g., {b1, b0}. The two-bit mode indicator may be interpreted based on the operating mode table 600 of FIG. 6 in accordance with some embodiments.

The mode indicator may include a value of {0, 0} to indicate the UE 104 is to operate in mode 1. In mode 1, the UE 104 may use single-TRP operation to transmit a PUCCH transmission using a first TCI state. The first TCI state may correspond to TRP 1.

The mode indicator may include a value of {0, 1} to indicate the UE 104 is to operate in mode 2. In mode 2, the UE 104 may use single-TRP operation to transmit a PUCCH transmission using a second TCI state. The second TCI state may correspond to TRP 2.

The mode indicator may include a value of {1, 0} to indicate the UE 104 is to operate in mode 3. In mode 3, the UE 104 may use mTRP operation to transmit PUCCH transmissions using both the first unified TCI state and the second unified TCI state, with the transmission associated with the first unified TCI state preceding the transmission associated with the second unified TCI state. Thus, in mode 3, the UE 104 may transmit a first PUCCH transmission to TRP 1 with the first unified TCI state and then transmit a second PUCCH transmission to TRP 2 with the second unified TCI state.

In some embodiments, mode 3 may be used for a mTRP PUCCH repetition scheme such as, e.g., described in section 9.2.6 of 3GPP TS 38.213 v17.4.0 (2023-01-04). Thus, the second PUCCH transmission to the TRP 2 will be a repetition of the first PUCCH transmission transmitted to the TRP 1.

The mode indicator may include a value of {1, 1} to indicate the UE 104 is to operate in mode 4. In mode 4, the UE 104 may use mTRP operation to transmit PUCCH transmissions using both the first unified TCI state and the second unified TCI state, with the transmission associated with the second unified TCI state preceding the transmission associated with the first unified TCI state. Thus, in mode 4, the UE 104 may transmit a first PUCCH transmission to TRP 2 with the second unified TCI state and then transmit a second PUCCH transmission to TRP 1 with the first unified TCI state.

In some embodiments, mode 4 may be used for a mTRP PUCCH repetition scheme such as, e.g., described in section 9.2.6 of 3GPP TS 38.213. Thus, the second PUCCH transmission to TRP 2 will be a repetition of the first PUCCH transmission transmitted to the TRP 1.

In other embodiments, the specific bit-value combinations associated with the various operating modes may be changed.

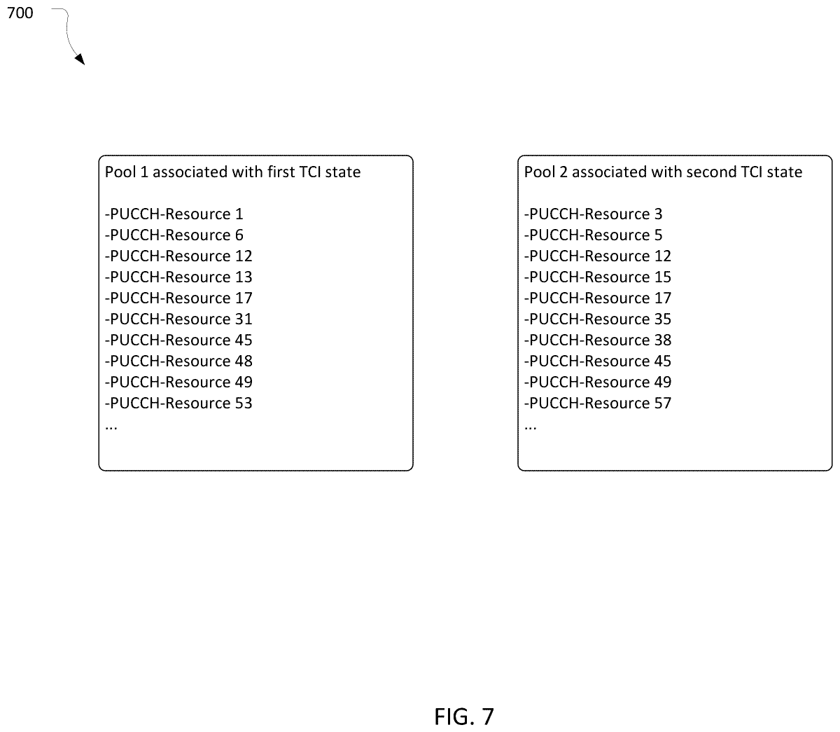

In a second option of the first PUCCH aspect, the access node 116 may use RRC to configure two pools of PUCCH resources such as pools 700 as shown in FIG. 7 in accordance with some embodiments.

A first pool 704 may include a list of PUCCH resources (e.g., PUCCH resource indexes/identifiers) that are associated with the first TCI state. A second pool 708 may include a list of PUCCH resources (e.g., PUCCH resource indexes/identifiers) that are associated with the second TCI state.

In the event the access node 116 wants the UE to only use the first TCI state for a PUCCH transmission, it will configure the UE 104 with PUCCH resources that are in the first pool 704 but not in the second pool 708, e.g., PUCCH resource 1. In the event the access node 116 wants the UE 104 to only use the second TCI state for a PUCCH transmission, it will configure the UE 104 with PUCCH resources that are in the second pool 708 but not in the first pool 704, e.g., PUCCH resource 3. In the event the access node 116 wants the UE 104 to use both the first TCI state and the second TCI state for PUCCH transmissions, it will configure the UE 104 with a PUCCH resource that is in both the first pool 704 and the second pool 708, e.g., PUCCH resource 12.

A second PUCCH aspect of the present disclosure is applicable to PUCCH transmissions when two unified TCI states are activated/indicated for mTRP UL operation. In these embodiments, the access node 116 may use a MAC CE to provide the mode indicator to indicate the operating mode in which the UE 104 is to operate.

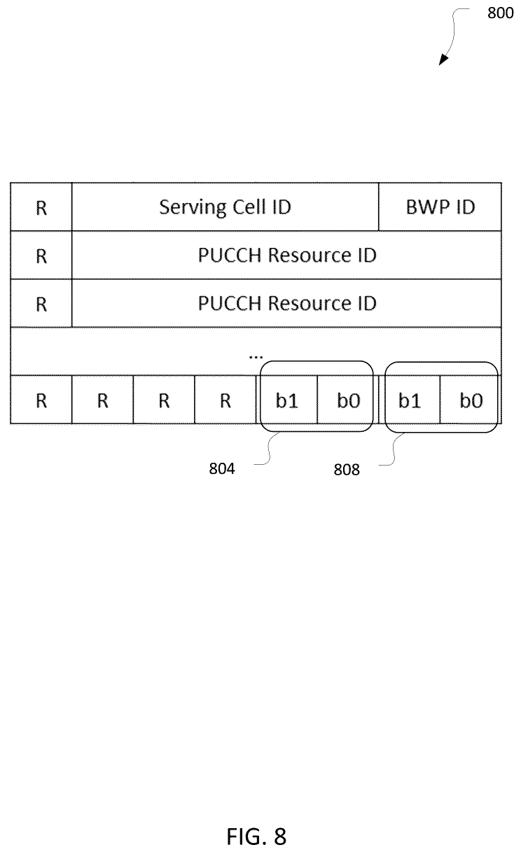

FIG. 8 illustrates a MAC CE 800 that may be used with respect to the second PUCCH aspect in accordance with some embodiments. The MAC CE 800 may include a first octet having a serving cell ID with, for example, five bits to indicate an identity of the serving cell for which the MAC CE 800 applies. The first octet may also include a BWP ID, which may be two bits to indicate a BWP for which the MAC CE 800 applies.

The MAC CE 800 may also include one or more PUCCH resource IDs in a respective one or more octets. Two are shown. Each PUCCH resource ID may be, for example, seven bits to indicate a PUCCH resource for which the MAC CE applies.

The MAC CE 800 may also include one or more mode indicators that respectively correspond to the one or more PUCCH resource IDs. For example, the MAC CE 800 may include a first two-bit mode indicator 804 that corresponds to the PUCCH resource ID in the second octet, and a second two-bit mode indicator 808 that corresponds to the PUCCH resource ID in the third octet. The interpretation of each of these mode indicators may be similar to that described above with respect to the first PUCCH aspect.

A third PUCCH aspect of the present disclosure is applicable to PUCCH transmissions when two unified TCI states are activated/indicated for single-DCI mTRP UL operation. In these embodiments, the access node 116 may also use a MAC CE to provide the mode indicator to indicate the operating mode in which the UE 104 is to operate.

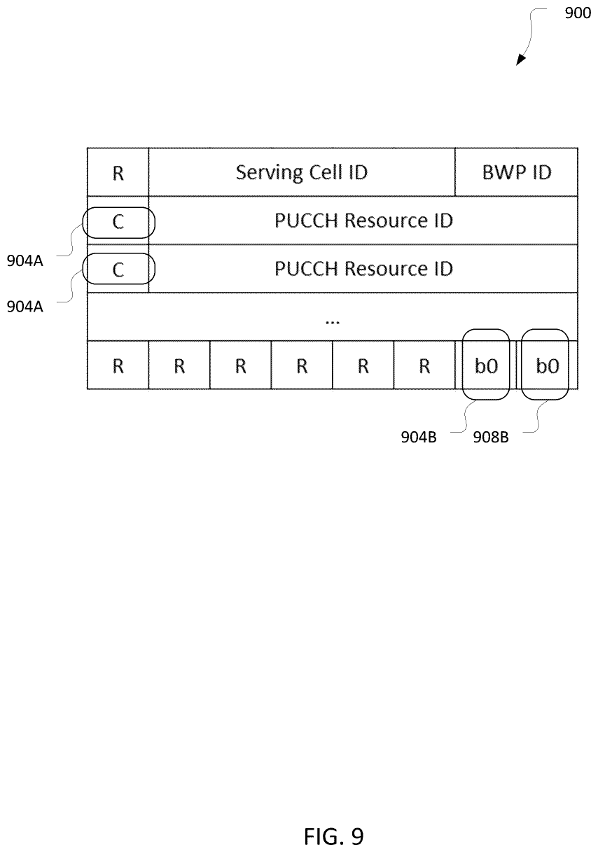

FIG. 9 illustrates a MAC CE 900 that may be used with respect to the third PUCCH aspect in accordance with some embodiments. The MAC CE 900 may include a first octet having a serving cell ID with, for example, five bits to indicate an identity of the serving cell for which the MAC CE 900 applies. The first octet may also include a BWP ID, which may be two bits to indicate a BWP for which the MAC CE 900 applies.

The MAC CE 900 may also include one or more PUCCH resource IDs in a respective one or more octets. Two are shown. Each PUCCH resource ID may be, for example, seven bits to indicate a PUCCH resource for which the MAC CE applies.

The MAC CE 900 may also include one or more mode indicators that respectively correspond to the one or more PUCCH resource IDs. For example, the MAC CE 900 may include a first two-bit mode indicator 904 that corresponds to the PUCCH resource ID in the second octet. The first two-bit mode indicator 904 may be in two parts. A first part, referred to as C 904A may be located in the octet that includes the associated PUCCH resource ID (e.g., the second octet). A second part, referred to as b0, may be located in a separate octet (e.g., the last octet). Similarly, the second two-bit mode indicator 908 may have a first part, referred to as C 908A, located in the octet that includes the associated PUCCH resource ID (e.g., the third octet) and a second part, referred to as b0 908B, located in a separate octet (e.g., the last octet).

The C values may indicate whether one or two TCI states are signaled for the PUCCH resource. For example, if C=0, one TCI state may be signaled for the corresponding PUCCH resource and b0 may indicate whether it is the first or second TCI state (e.g., mode 1 or 2 as described in the operating mode table 600). For example, C=0 and b0=0 may map to mode 1 (e.g., {b1, b0}={0, 0} of operating mode table 600) in which the PUCCH resource is associated with the first TCI state. And C=0 and b0=1 may map to mode 2 (e.g., {b1, b0}={0, 1} of operating mode table 600) in which the PUCCH resource is associated with the second TCI state.

If C=0, two TCI states may be signaled for the corresponding PUCCH resource and b0 may indicate the order in which the TCI states are used (e.g., mode 3 or 4 as described in the operating mode table 600). For example, C=1 and b0=0 may map to mode 3 (e.g., {b1, b0}={1, 0} of operating mode table 600) in which a first PUCCH transmission using the PUCCH resource is transmitted using the first TCI state before a second PUCCH transmission using the PUCCH resource is transmitted using the second TCI state. And, C=1 and b0=1 may map to mode 4 (e.g., {b1, b0}={1, 1} of operating mode table 600) in which a first PUCCH transmission using the PUCCH resource is transmitted using the second TCI state before a second PUCCH transmission using the PUCCH resource is transmitted using the first TCI state

The interpretation of each of these mode indicators may be similar to that described above with respect to the first PUCCH aspect.

A fourth PUCCH aspect of the present disclosure is applicable to PUCCH transmissions when two PUCCH power control sets are activated/indicated for single-DCI mTRP UL operation. In some embodiments, the fourth PUCCH aspect may correspond to operation in frequency range 1 (FR1), which may include frequencies below 7.125 GHz.

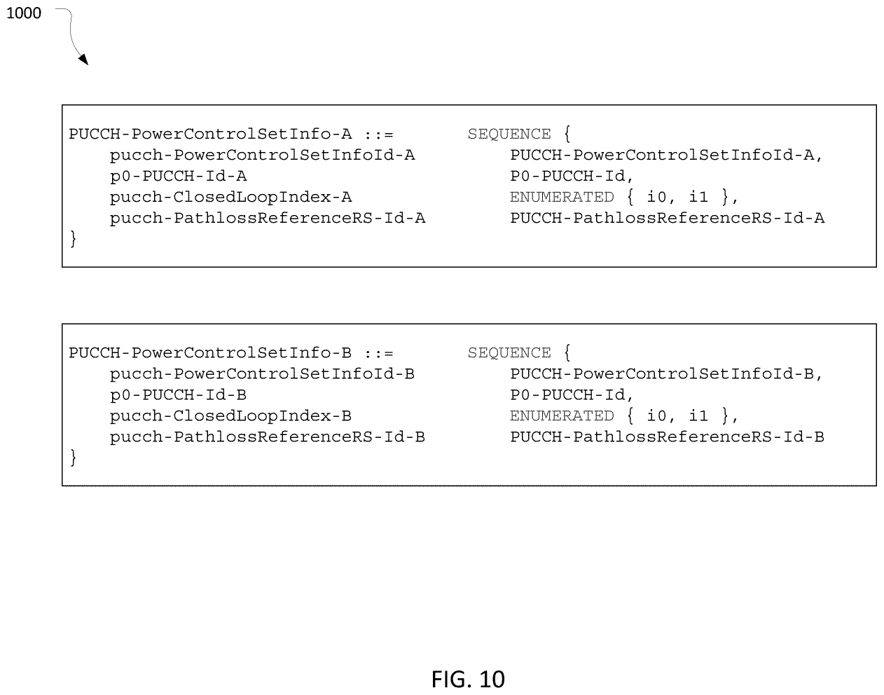

FIG. 10 illustrates PUCCH power control set configurations 1000 in accordance with some embodiments. The access node 116 may use RRC signaling to provide the PUCCH power control set configurations 1000 to the UE 104. The UE 104 may use the PUCCH power control set configurations 1000 to adjust its transmit power when transmitting one or more PUCCH transmissions.

The PUCCH power control set configurations 1000 may include a PUCCH power control set information (PUCCH-PowerControlSetInfo-A) IE 1004 and a PUCCH-PowerControlSetInfo-B IE 1008. The PUCCH-PowerControlSetInfo-A IE 1004 and PUCCH-PowerControlSetInfo-B IE 1008 may be in a PUCCH power control (PUCCH-PowerControl)

IE that is used to configure UE-specific parameters for the power control of the PUCCH. In some embodiments, the suffixes “A” and “B” of the PUCCH-PowerControlSetInfo-A IE 1004 and the PUCCH-PowerControlSetInfo-B IE 1008 may refer to different 3GPP releases (e.g., A=R17 and B=R18).

The access node 116 may then use control signaling (for example, MAC-CE or DCI, to activate/indicate one or two of the PUCCH power control sets. The UE 104 may use the power control parameters from the activated set when transmitting the PUCCH transmission(s).

A fifth PUCCH aspect of the present disclosure is applicable to PUCCH transmissions when two PUCCH power control sets are activated/indicated for single-DCI mTRP UL operation. In some embodiments, the fifth PUCCH aspect may correspond to operation in FR1.

With respect to the fifth PUCCH aspect, the signaling of the PUCCH power control parameter set that is to be used for the PUCCH transmissions may be signaled in a manner similar to the signaling of the first, second, and third PUCCH aspects, except with respect to the PUCCH power control parameter sets instead of TCI states. For example, the mode indicator in these embodiments may indicate that the UE 104 is to operate in: a single-TRP PUCCH mode in which a PUCCH transmission is to be transmitted using the first PUCCH power control parameter set: a second single-TRP PUCCH mode in which a PUCCH transmission is to be transmitted using the second PUCCH power control parameter set: an mTRP mode in which a first PUCCH transmission is to be transmitted using the first PUCCH power control parameter set and a second PUCCH transmission is to be transmitted using a second PUCCH power control parameter set: or an mTRP mode in which a first PUCCH transmission is to be transmitted using the second PUCCH power control parameter set and a second PUCCH transmission is to be transmitted using the first PUCCH power control parameter set. The mode indicator may be transmitted using RRC configurations as described in the first PUCCH aspect or a MAC CE as described in the second or third PUCCH aspects.

SRSs, e.g., SRS resources, may be categorized in different ways. A first way of categorizing SRSs may be based on usage. For example, whether the SRS is for: codebook-based PUSCH, non-codebook-based PUSCH, beam management, or antenna switching. A second way of categorizing SRSs may be based on time-domain behavior. For example, whether SRS is a periodic SRS (P-SRS), semi-persistent SRS (SPS-SRS), or aperiodic SRS (AP-SRS).

Two SRS aspects will be described as follows.

A first SRS aspect of the present disclosure is applicable to SRS transmissions when two unified TCI states are activated/indicated for mTRP UL operation. In these embodiments, the TCI state that may be used for the SRS transmission may be signaled by RRC.

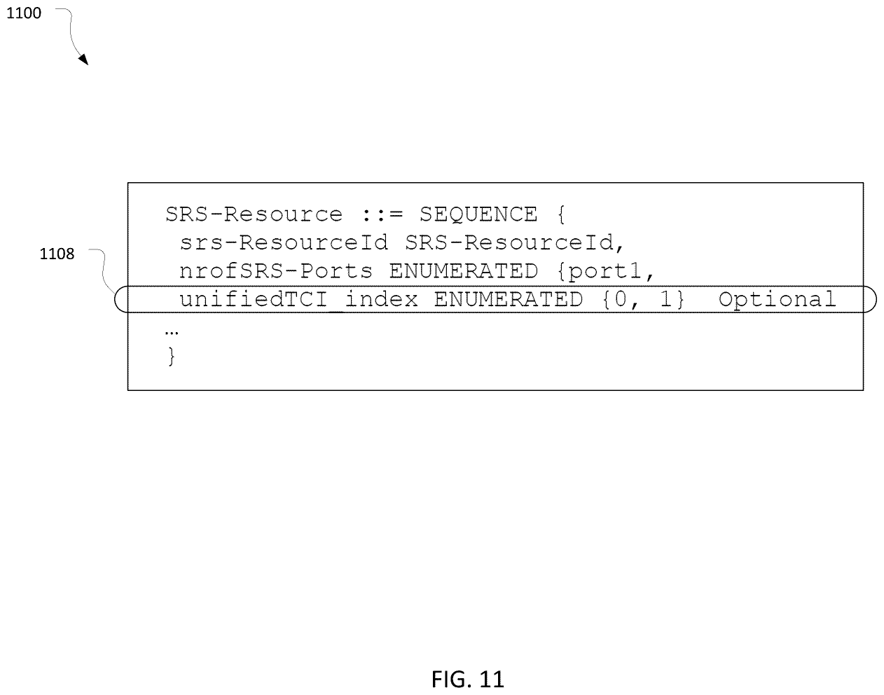

FIG. 11 includes an SRS-Resource configuration 1100 in accordance with some embodiments. The SRS-Resource configuration 1100 may include a mode indicator 1104. The mode indicator may be a one-bit indicator. If the mode indicator is set to 0, the UE 104 may operate in a first mode in which the SRS transmission using the SRS resource is to use the first TCI state. If the mode indicator is set to 1, the UE 104 may operate in a second mode in which the SRS transmission using the SRS resource is to use the second TCI state.

A second SRS aspect of the present disclosure is also applicable to SRS transmissions when two unified TCI states are activated/indicated for mTRP UL operation. In these embodiments, the TCI state that may be used for the SRS transmission may be signaled by a MAC CE.

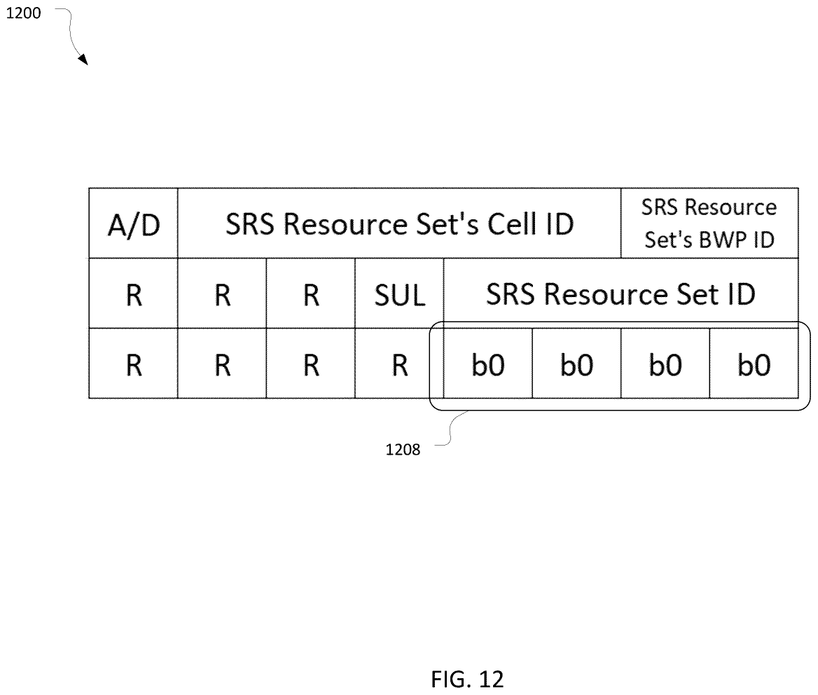

FIG. 12 illustrates a MAC CE 1200 that may be used for the second SRS aspect in accordance with some embodiments.

The MAC CE 1200 may include a first octet having an A/D field to indicate whether to activate or deactivate an indicated SP SRS-ResourceSet: an SRS resource set cell ID with, for example, five bits to indicate an identity of the serving cell for which the MAC CE 1200 applies; and an SRS resource set BWP ID with, for example, two bits to indicate the BWP for which the MAC CE 1200 applies.

The MAC CE 1200 may include a second octet having an SUL field to indicate whether the MAC CE 1200 applies to a normal uplink (NUL) or a supplemental uplink (SUL); and an SP SRS resource set ID to indicate an identifier of an SP/AP SRS-ResourceSet.

The MAC CE 1200 may further include a third octet having one or more mode indicators, b0. As shown, the MAC CE 1200 may include four mode indicators 1208. Each mode indicator {b0} may correspond to one SP SRS-Resource in the SRS-ResourceSet. If the mode indicator includes a value ‘0,’ the first activated/indicated TCI state may be used. If the mode indicator includes a value ‘1,’ the second activated/indicated TCI state may be used.

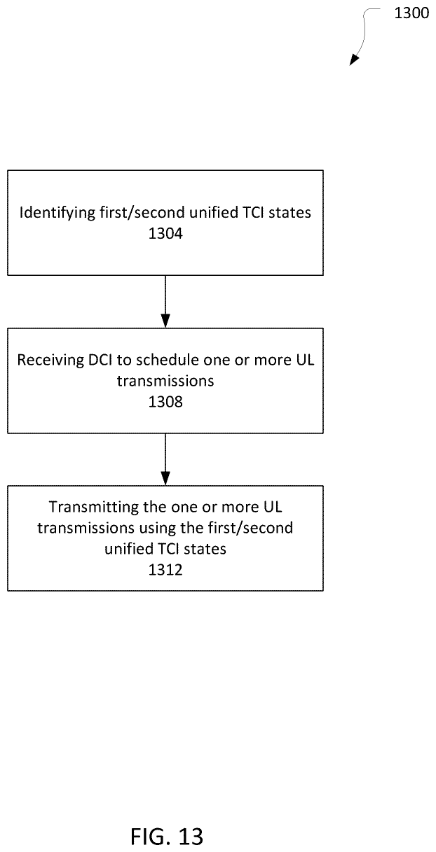

FIG. 13 illustrates an operational flow/algorithmic structure 1300 for single DCI mTRP operation in accordance with some embodiments. The operational flow/algorithmic structure 1300 may be implemented by a UE such as, for example, UE 104, UE 1700, or components therein, for example, processors 1704.

The operational flow/algorithmic structure 1300 may include, at 1304, identifying first and second unified TCI states. The first and second unified TCI states may be associated with mTRP uplink operation and selected from at least one TCI list from one or more TCI lists stored on the UE. The first and second unified TCI states may both be joint unified TCI states, both be unified UL TCI states, or one of each. The lists may include downlink-or-joint TCI state list or uplink TCI state list that may be associated with first/second TRPs in a manner similar to that described above with respect to FIG. 2.

In some embodiments, the first/second unified TCI states may be identified through a MAC-CE based indication or a MAC-CE+DCI based indication.

The operational flow/algorithmic structure 1300 may further include, at 1308, receiving DCI to schedule one or more uplink transmissions.

In some embodiments, the DCI may schedule one or more PUCCH transmissions. The UE may receive a mode indicator that indicates an uplink operating mode. The mode indicator may be received by DCI, RRC, or MAC CE as described elsewhere herein. The uplink operating mode may be a single-TRP UL operating mode in which the UE uses the first unified TCI state: a single-TRP UL operating mode in which the UE uses the second unified TCI state: a multi-TRP UL operating mode in which the UE uses the first unified TCI state for a first transmission of the one or more PUCCH transmissions and the second unified TCI state for a second transmission of the one or more PUCCH transmissions: or a multi-TRP UL operating mode in which the UE uses the second unified TCI state for a first transmission of the one or more PUCCH transmissions and the first unified TCI state for a second transmission of the one or more PUCCH transmissions.

The operational flow/algorithmic structure 1300 may further include, at 1312, transmitting the one or more UL transmissions using the first/second unified TCI states. In the event the UE received a mode indicator, the UE may transmit the UL transmissions with the first/second unified TCI states using an uplink operating mode indicated by the mode indicator.

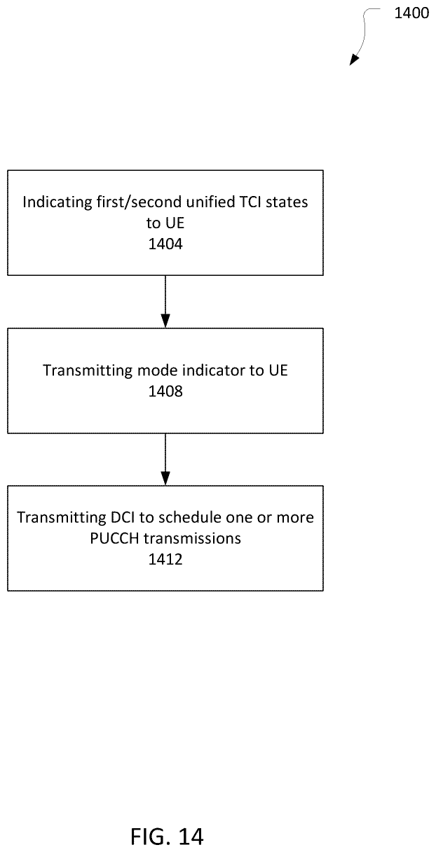

FIG. 14 illustrates an operational flow/algorithmic structure 1400 for configuring mTRP UL transmissions in accordance with some embodiments. The operational flow/algorithmic structure 1400 may be implemented by an access node such as, for example, access node 116, network node 1800, or components therein, for example, processors 1804.

The operational flow/algorithmic structure 1400 may include, at 1404, indicating first and second unified TCI states to a UE. The base station may provide this indication using a MAC CE-based indication or a MAC CE+ DCI-based indication as described elsewhere herein.

The operational flow/algorithmic structure 1400 may further include, at 1408, transmitting a mode indicator to indicate an uplink operating mode. The mode indicator may be transmitted by RRC signaling, MAC CE, or DCI (either scheduling DCI or a non-scheduling DCI) as described elsewhere herein. In some embodiments, the mode indicator may be transmitted in a PUCCH resource configuration or a PUCCH-resource-pool configuration. The uplink operating mode may be a single-TRP UL operating mode in which the UE is to use the first unified TCI state for the PUCCH transmission: a single-TRP UL operating mode in which the UE is to use the second unified TCI state for the one or more PUCCH transmissions: or a multi-TRP UL operating mode in which the UE is to use both the first unified TCI state and the second unified TCI state for the one or more PUCCH transmissions. If the uplink operating mode is the multi-TRP UL operating mode, some embodiments may further include a substrate of whether the first TCI state is used before or after the second TCI state.

The operational flow/algorithmic structure 1400 may further include, at 1412, transmitting DCI to schedule one or more PUCCH transmissions. In some embodiments, the mode indicator may be included in the DCI transmitted at 1412.

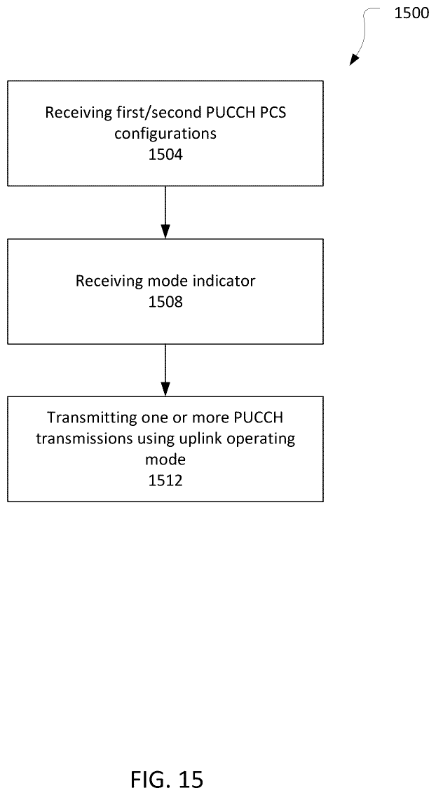

FIG. 15 illustrates an operational flow/algorithmic structure 1500 for transmitting PUCCH transmissions in accordance with some embodiments. The operational flow/algorithmic structure 1500 may be implemented by a UE such as, for example, UE 104 or 1700 or components therein, for example, processors 1704.

The operational flow/algorithmic structure 1500 may include, at 1504, receiving first and second PUCCH power control set (PCS) configurations. These configurations, which may be similar to that described above with respect to FIG. 10, may be for mTRP uplink operation.

The operational flow/algorithmic structure 1500 may further include, at 1508, receiving a mode indicator to indicate an uplink operating mode. The mode indicator may be received in RRC signaling, DCI, or a MAC CE as described elsewhere herein.

The uplink operating mode, indicated by the mode indicator, may be a single-TRP UL operating mode in which the UE is to use the first PUCCH PCS configuration for the one or more PUCCH transmissions: a single-TRP UL operating mode in which the UE is to use the second PUCCH PCS configuration: or a multi-TRP UL operating mode in which the UE is to use both the first PUCCH PCS configuration and the second PUCCH PCS configuration for the one or more PUCCH transmissions.

The operational flow/algorithmic structure 1500 may further include, at 1512, transmitting one or more PUCCH transmissions using the uplink operating mode. For example, the one or more PUCCH transmissions may be transmitted with an uplink transmit power based on the first or second PUCCH PCS configurations.

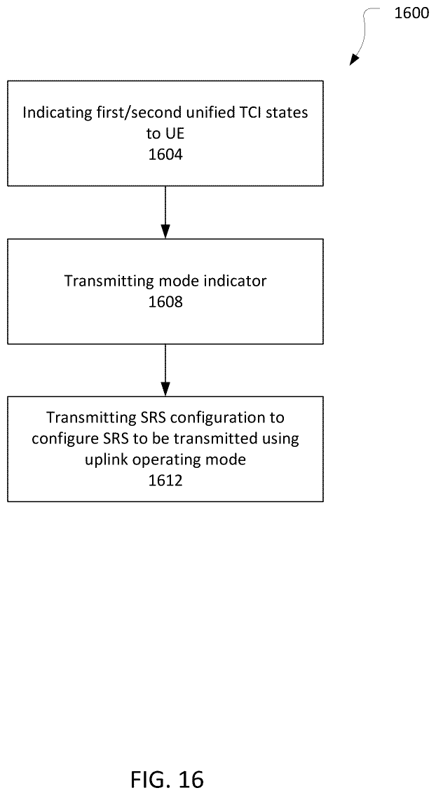

FIG. 16 illustrates an operational flow/algorithmic structure 1600 for configuring mTRP UL transmissions in accordance with some embodiments. The operational flow/algorithmic structure 1600 may be implemented by an access node such as, for example, access node 116, network node 1800, or components therein, for example, processors 1804.

The operational flow/algorithmic structure 1600 may include, at 1604, indicating first and second unified TCI states to a UE. The base station may provide this indication using a MAC CE-based indication or a MAC CE+ DCI-based indication as described elsewhere herein.

The operational flow/algorithmic structure 1600 may further include, at 1608, transmitting a mode indicator to indicate an uplink operating mode. The mode indicator may be transmitted by RRC signaling, MAC CE, or DCI (either scheduling DCI or a non-scheduling DCI) as described elsewhere herein. The uplink operating mode may be a single-TRP UL operating mode in which the UE is to use the first unified TCI state for an SRS transmission: or a single-TRP UL operating mode in which the UE is to use the second unified TCI state for the SRS.

The operational flow/algorithmic structure 1600 may further include, at 1612, transmitting an SRS configuration to configure the SRS to be transmitted using the uplink operating mode. In some embodiments, the mode indicator may be included in the SRS configuration transmitted at 1612.

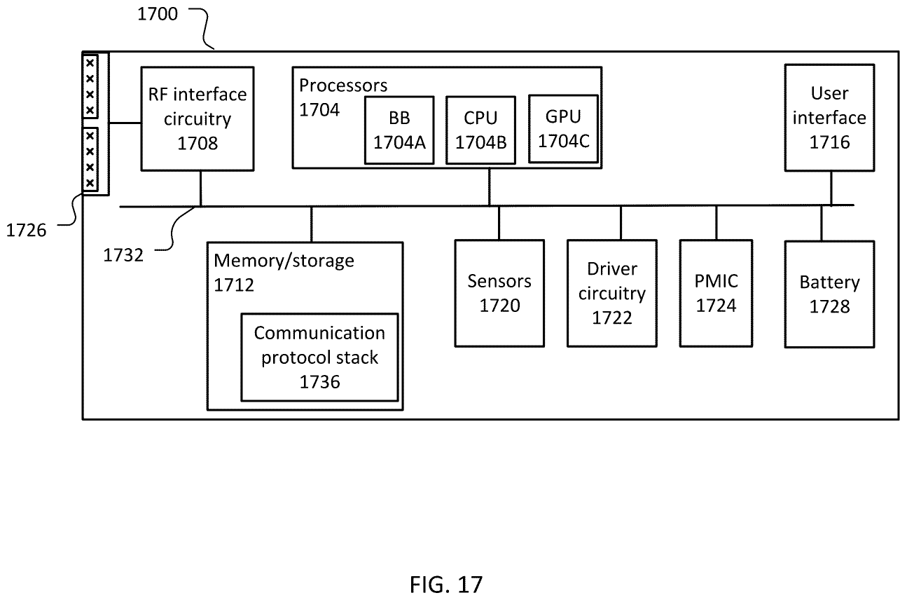

FIG. 17 illustrates a UE 1700 in accordance with some embodiments. The UE 1700 may be similar to and substantially interchangeable with UE 104 of FIG. 1.

The UE 1700 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1700 may include processors 1704, RF interface circuitry 1708, memory/storage 1712, user interface 1716, sensors 1720, driver circuitry 1722, power management integrated circuit (PMIC) 1724, antenna structure 1726, and battery 1728. The components of the UE 1700 may be implemented as integrated circuits (ICs), portions thereof, discrete electronic devices, or other modules, logic, hardware, software, firmware, or a combination thereof. The block diagram of FIG. 17 is intended to show a high-level view of some of the components of the UE 1700. However, some of the components shown may be omitted, additional components may be present, and different arrangement of the components shown may occur in other implementations.

The components of the UE 1700 may be coupled with various other components over one or more interconnects 1732, which may represent any type of interface, input/output, bus (local, system, or expansion), transmission line, trace, or optical connection that allows various circuit components (on common or different chips or chipsets) to interact with one another.

The processors 1704 may include processor circuitry such as, for example, baseband processor circuitry (BB) 1704A, central processor unit circuitry (CPU) 1704B, and graphics processor unit circuitry (GPU) 1704C. The processors 1704 may include any type of circuitry or processor circuitry that executes or otherwise operates computer-executable instructions, such as program code, software modules, or functional processes from memory/storage 1712 to cause the UE 1700 to perform operations as described herein.

In some embodiments, the baseband processor circuitry 1704A may access a communication protocol stack 1736 in the memory/storage 1712 to communicate over a 3GPP compatible network. In general, the baseband processor circuitry 1704A may access the communication protocol stack 1736 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1708.

The baseband processor circuitry 1704A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1712 may include one or more non-transitory, computer-readable media that includes instructions (for example, communication protocol stack 1736) that may be executed by one or more of the processors 1704 to cause the UE 1700 to perform various single DCI mTRP uplink operations as described herein. For example, the processors 1704 may cause the UE to perform the operational flow/algorithmic structure 1300, 1500, or any other method or process describe herein.

The memory/storage 1712 include any type of volatile or non-volatile memory that may be distributed throughout the UE 1700. In some embodiments, some of the memory/storage 1712 may be located on the processors 1704 themselves (for example, L1 and L2 cache), while other memory/storage 1712 is external to the processors 1704 but accessible thereto via a memory interface. The memory/storage 1712 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1708 may include transceiver circuitry and radio frequency front module (RFEM) that allows the UE 1700 to communicate with other devices over a radio access network. The RF interface circuitry 1708 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1726 and proceed to filter and amplify (with a low-noise amplifier) the signal. The signal may be provided to a receiver of the transceiver that down-converts the RF signal into a baseband signal that is provided to the baseband processor of the processors 1704.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1726.

In various embodiments, the RF interface circuitry 1708 may be configured to transmit/receive signals in a manner compatible with NR access technologies.

The antenna structure 1726 may include antenna elements to convert electrical signals into radio waves to travel through the air and to convert received radio waves into electrical signals. The antenna elements may be arranged into one or more antenna panels. The antenna structure 1726 may have antenna panels that are omnidirectional, directional, or a combination thereof to enable beamforming and multiple input, multiple output communications. The antenna structure 1726 may include microstrip antennas, printed antennas fabricated on the surface of one or more printed circuit boards, patch antennas, or phased array antennas. The antenna structure 1726 may have one or more panels designed for specific frequency bands including bands in FR1 or FR2.

The user interface 1716 includes various input/output (I/O) devices designed to enable user interaction with the UE 1700. The user interface 1716 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1700.

The sensors 1720 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers: microelectromechanical systems or nanoelectromechanical systems comprising 3-axis accelerometers, 3-axis gyroscopes, or magnetometers: level sensors: flow sensors: temperature sensors (for example, thermistors): pressure sensors: barometric pressure sensors: gravimeters: altimeters: image capture devices (for example, cameras or lensless apertures): light detection and ranging sensors: proximity sensors (for example, infrared radiation detector and the like): depth sensors: ambient light sensors: ultrasonic transceivers; and microphones or other like audio capture devices.

The driver circuitry 1722 may include software and hardware elements that operate to control particular devices that are embedded in the UE 1700, attached to the UE 1700, or otherwise communicatively coupled with the UE 1700. The driver circuitry 1722 may include individual drivers allowing other components to interact with or control various I/O devices that may be present within, or connected to, the UE 1700. For example, the driver circuitry 1722 may include circuitry to facilitate coupling of a UICC (for example, UICC 178) to the UE 1700. For additional examples, driver circuitry 1722 may include a display driver to control and allow access to a display device, a touchscreen driver to control and allow access to a touchscreen interface, sensor drivers to obtain sensor readings of sensors 1720 and control and allow access to sensors 1720, drivers to obtain actuator positions of electro-mechanic components or control and allow access to the electro-mechanic components, a camera driver to control and allow access to an embedded image capture device, audio drivers to control and allow access to one or more audio devices.

The PMIC 1724 may manage power provided to various components of the UE 1700. In particular, with respect to the processors 1704, the PMIC 1724 may control power-source selection, voltage scaling, battery charging, or DC-to-DC conversion.

In some embodiments, the PMIC 1724 may control, or otherwise be part of, various power saving mechanisms of the UE 1700 including DRX as discussed herein.

A battery 1728 may power the UE 1700, although in some examples the UE 1700 may be mounted deployed in a fixed location and may have a power supply coupled to an electrical grid. The battery 1728 may be a lithium ion battery, a metal-air battery, such as a zinc-air battery, an aluminum-air battery, a lithium-air battery, and the like. In some implementations, such as in vehicle-based applications, the battery 1728 may be a typical lead-acid automotive battery.

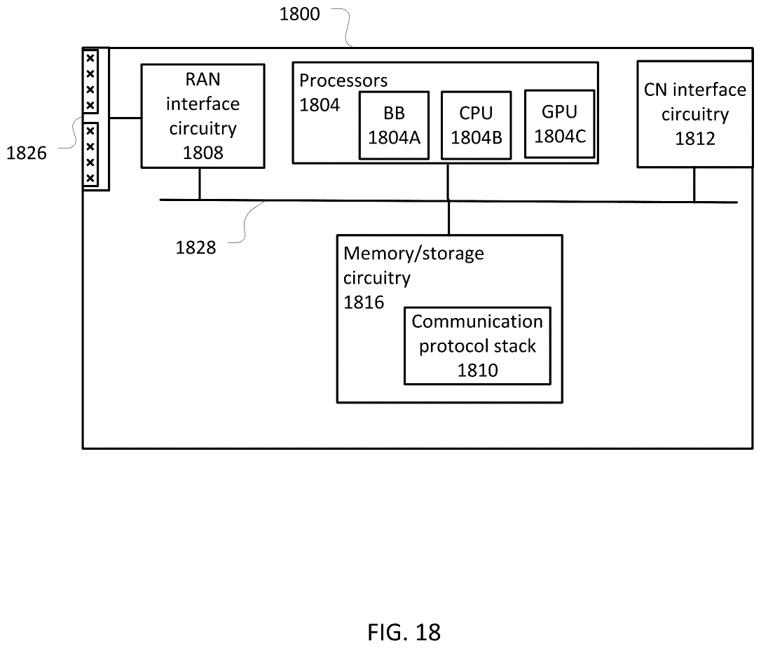

FIG. 18 illustrates a network node 1800 in accordance with some embodiments. The network node 1800 may be similar to and substantially interchangeable with access node 186 or base station 188.

The network node 1800 may include processors 1804, RF interface circuitry 1808 (if implemented as an access node), core network (CN) interface circuitry 1812, memory/storage 1816, and antenna structure 1826.

The components of the network node 1800 may be coupled with various other components over one or more interconnects 1828.

The processors 1804, RF interface circuitry 1808, memory/storage 1816 (including communication protocol stack 1810), antenna structure 1826, and interconnects 1828 may be similar to like-named elements shown and described with respect to FIG. 17.

The memory/storage 1816 may include one or more non-transitory, computer-readable media that includes instructions (for example, communication protocol stack 1810) that may be executed by one or more of the processors 1804 to cause the network node 1800 to perform single DCI mTRP operations as described herein. For example, the processors 1804 may cause the network node 1800 to perform the operational flow/algorithmic structure 1400, 1600, or any other method or process described herein.

The CN interface circuitry 1812 may provide connectivity to a core network, for example, a 5th Generation Core network (5GC) using a 5GC-compatible network interface protocol such as carrier Ethernet protocols, or some other suitable protocol. Network connectivity may be provided to/from the network node 1800 via a fiber optic or wireless backhaul. The CN interface circuitry 1812 may include one or more dedicated processors or FPGAs to communicate using one or more of the aforementioned protocols. In some implementations, the CN interface circuitry 1812 may include multiple controllers to provide connectivity to other networks using the same or different protocols.

In some embodiments, the network node 1800 may be coupled with transmit receive points (TRPs) using the antenna structure 1826, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary aspects are provided.

Example 1 includes a method of operating a user equipment (UE), the method comprising: identifying a first unified transmission configuration indicator (TCI) state and a second unified TCI state, the first unified TCI state and the second unified TCI states associated with a multiple-transmit-receive point (TRP) uplink operation and selected from at least one TCI list from one or more TCI lists stored on the UE: receiving downlink control information (DCI), a media access control (MAC) control element (CE), or radio resource control (RRC) signaling to schedule one or more uplink transmissions; and transmitting the one or more uplink transmissions using the first unified TCI state or the second unified TCI state.

Example 2 includes the method of example 1 or some other example herein, further comprising: transmitting the one or more uplink transmissions using the first unified TCI state and the second unified TCI state.

Example 3 includes a method of example 2 or some other example herein claim 2, wherein both the first unified TCI state and the second unified TCI state are joint unified TCI states.

Example 4 includes a method of example 2 or some other example herein, wherein both the first unified TCI state and the second unified TCI state are uplink unified TCI states.

Example 5 includes a method of example 2 or some other example herein, wherein the first unified TCI state is a joint unified TCI state and the second TCI state is an uplink unified TCI state.

Example 6 includes a method of example 1 or some other example herein, wherein the one or more TCI lists comprise: a downlink or joint TCI state list that corresponds to both a first TRP and a second TRP: a downlink or joint TCI state list and an uplink TCI state list that corresponds to both a first TRP and a second TRP: or a first downlink or joint TCI state list that corresponds to a first TRP, a second downlink or joint TCI state list that corresponds to a second TRP, and an uplink TCI state list that corresponds to the second TRP.

Example 7 includes the method of example 1 or some other example herein, wherein the DCI is to schedule one or more physical uplink shared channel (PUSCH) transmissions, and the method further comprises: receiving a mode indicator to indicate an uplink operating mode; and transmitting the one or more PUSCH transmissions using the uplink operating mode.

Example 8 includes a method of example 7 or some other example herein, wherein the uplink operating mode comprises: a single-TRP UL operating mode in which the UE uses the first unified TCI state: a single-TRP UL operating mode in which the UE uses the second unified TCI state: a multi-TRP UL operating mode in which the UE uses the first unified TCI state for a first transmission of the one or more PUSCH transmissions and the second unified TCI state for a second transmission of the one or more PUSCH transmissions; or a multi-TRP UL operating mode in which the UE uses the second unified TCI state for a first transmission of the one or more PUSCH transmissions and the first unified TCI state for a second transmission of the one or more PUSCH transmissions.

Example 9 includes the method of example 7 or 8 or some other example herein, further comprising: receiving the mode indicator in radio resource control (RRC) signaling or a media access control (MAC) control element (CE).

Example 10 includes a method of example 9 or some other example herein, further comprising: receiving the mode indicator in a MAC CE, wherein the MAC CE includes a serving cell identifier: bandwidth part identifier: configured grant identifier; and two bits to provide the mode indicator.

Example 11 includes the method of example 7 or 8 or some other example herein, wherein the DCI is scheduling DCI and the method further comprises: receiving the mode indicator in the scheduling DCI or a non-scheduling DCI.

Example 12 includes the method of example 11 or some other example herein, further comprising: receiving the mode indicator in a sounding reference signal (SRS) set indicator of the scheduling DCI or a non-scheduling DCI.

Example 13 includes the method of example 11 or some other example herein, further comprising: operating in the uplink operating mode: to transmit the one or more PUSCH transmissions: until receipt of an updated uplink operating mode: or from a predetermined period of time from receiving the mode indicator.

Example 14 includes the method of example 7 or 8 or some other example herein, wherein the one or more PUSCH transmission comprises a dynamic grant (DG) PUSCH transmission or a configured grant (CG) PUSCH transmission.

Example 15 includes the method of example 14 or some other example herein, wherein the one or more PUSCH transmission comprises a CG PUSCH transmission and the method comprises: receiving a configuration parameter that includes one or more uplink operating modes, the one or more uplink operating modes to include the uplink operating mode.

Example 16 includes a method of example 15 or some other example herein, wherein the CG PUSCH transmission is a type 1 CG PUSCH transmission and the configuration parameter is within a configured grant configuration (ConfiguredGrantConfig) information element to provide the mode indicator.

Example 17 includes a method of example 15 or some other example herein, wherein the CG PUSCH transmission is a type 2 CG PUSCH transmission, the configuration parameter is indicated by a field in downlink control information (DCI) that activates the type 2 CG PUSCH transmission, and the method further comprises: receiving the mode indicator in the DCI.

Example 18 includes a method of operating a base station, the method comprising: indicating, to a user equipment (UE), a first unified transmission configuration indicator (TCI) state and a second unified TCI state for a multiple-transmit-receive point (TRP) uplink operation: transmitting, to the UE, a mode indicator to indicate an uplink operating mode; and transmitting, to the UE, downlink control information (DCI), a media access control (MAC) control element (CE), or radio resource control (RRC) signaling to schedule one or more physical uplink control channel (PUCCH) transmissions to be transmitted using the uplink operating mode.

Example 19 includes the method of example 18 or some other example herein, wherein the uplink operating mode comprises: a single-TRP UL operating mode in which the UE is to use the first unified TCI state for the PUCCH transmission: a single-TRP UL operating mode in which the UE is to use the second unified TCI state for the one or more PUCCH transmissions: or a multi-TRP UL operating mode in which the UE is to use both the first unified TCI state and the second unified TCI state for the one or more PUCCH transmissions.

Example 20 includes the method of example 18 or 19 or some other example herein, further comprising: transmitting a PUCCH resource configuration for the one or more PUCCH transmissions, the PUCCH resource configuration having the mode indicator.

Example 21 includes a method of example 18 or 19 or some other example herein, further comprising: transmitting a PUCCH resource configuration for the one or more PUCCH transmissions; and transmitting one or more PUCCH-resource-pool configurations that include the mode indicator.

Example 22 includes the method of example 21 or some other example herein, wherein the PUCCH resource configuration has a PUCCH-resource index, the one or more PUCCH-resource-pool configurations include a first PUCCH-resource-pool configuration associated with the first unified TCI state and a second PUCCH-resource-pool configuration associated with the second unified TCI state, and the mode indicator is provided by inclusion of the PUCCH-resource index in the first PUCCH-resource-pool configuration or the second PUCCH-resource-pool configuration.

Example 23 includes method of example 18 or 19 or some other example herein, further comprising: configuring a PUCCH resource for the one or more PUCCH transmissions, the PUCCH resource having a PUCCH resource identifier; and transmitting a media access control (MAC) control element (CE) having the PUCCH resource identifier and two bits, associated with the PUCCH resource identifier, to provide the mode indicator.

Example 24 includes the method of example 23 or some other example herein, wherein the MAC CE includes a first octet with the PUCCH resource identifier and a first bit of the two bits and a second octet with a second bit of the two bits.

Example 25 includes the method of example 24 some other example herein, wherein the first bit indicates whether the uplink operating mode is a single-TRP UL operating mode or a multi-TRP UL operating mode.

Example 26 includes a method of operating a user equipment (UE), the method comprising: receiving a first physical uplink control channel (PUCCH) power control set (PCS) configuration and a second PUCCH PCS configuration for a multiple-transmit-receive point (TRP) uplink operation: receiving a mode indicator to indicate an uplink operating mode; and transmitting one or more PUCCH transmissions using the uplink operating mode based on the first PUCCH PCS or the second PUCCH PCS.

Example 27 includes the method of example 26 or some other example herein, wherein the uplink operating mode comprises: a single-TRP UL operating mode in which the UE is to use the first PUCCH PCS configuration for the one or more PUCCH transmissions; a single-TRP UL operating mode in which the UE is to use the second PUCCH PCS configuration: or a multi-TRP UL operating mode in which the UE is to use both the first PUCCH PCS configuration and the second PUCCH PCS configuration for the one or more PUCCH transmissions.

Example 28 includes a method of example 26 or 27 or some other example herein, further comprising: transmitting a PUCCH resource configuration for the one or more PUCCH transmissions, the PUCCH resource configuration having the mode indicator.

Example 29 includes the method of example 26 or 27 or some other example herein, further comprising: receiving the mode indicator in downlink control information, a media access control (MAC) control element (CE), or radio resource control (RRC) signaling.

Example 30 includes a method of operating a base station, the method comprising: indicating, to a user equipment (UE), a first unified transmission configuration indicator (TCI) state and a second unified TCI state for a multiple-transmit-receive point (TRP) uplink operation: transmitting, to the UE, a mode indicator to indicate an uplink operating mode; and transmitting, to the UE, sounding reference signal (SRS) configuration to configure an SRS to be transmitted using the uplink operating mode.

Example 31 includes the method of example 30 or some other example herein, wherein the uplink operating mode comprises: a single-TRP UL operating mode in which the UE is to use the first unified TCI state for the SRS: or a single-TRP UL operating mode in which the UE is to use the second unified TCI state for the SRS.

Example 32 includes the method of example 30 or 31 or some other example herein, wherein the SRS configuration includes the mode indicator.

Example 33 includes the method of example 30 or 31 or some other example herein, further comprising: receiving the mode indicator in a media access control (MAC) control element (CE) that configures operating modes of an SRS resource set that includes the SRS resource.

Another example may include one or more non-transitory computer-readable media comprising instructions to cause an electronic device, upon execution of the instructions by one or more processors of the electronic device, to perform one or more elements of a method described in or related to any of examples 1-33, or any other method or process described herein.

Another example may include an apparatus comprising logic, modules, or circuitry to perform one or more elements of a method described in or related to any of examples 1-33, or any other method or process described herein.

Another example may include a method, technique, or process as described in or related to any of examples 1-33, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-33, or portions thereof.

Another example may include a signal as described in or related to any of examples 1-33, or portions or parts thereof.

Another example may include a datagram, information element, packet, frame, segment, PDU, or message as described in or related to any of examples 1-33, or portions or parts thereof, or otherwise described in the present disclosure.

Another example may include a signal encoded with data as described in or related to any of examples 1-33, or portions or parts thereof, or otherwise described in the present disclosure.

Another example may include a signal encoded with a datagram, IE, packet, frame, segment, PDU, or message as described in or related to any of examples 1-33, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-33, or portions thereof.

Another example may include a computer program comprising instructions, wherein execution of the program by a processing element is to cause the processing element to carry out the method, techniques, or process as described in or related to any of examples 1-33, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify a first unified transmission configuration indicator (TCI) state and a second unified TCI state, the first unified TCI state and the second unified TCI states associated with a multiple-transmit-receive point (TRP) uplink operation and selected from at least one TCI list from one or more stored TCI lists;
process downlink control information (DCI), a media access control (MAC) control element (CE), or radio resource control (RRC) signaling that schedules one or more uplink transmissions; and
generate the one or more uplink transmissions using the first unified TCI state or the second unified TCI state.

2. The one or more non-transitory, computer-readable media of claim 1, wherein the instructions, when executed, further cause the processing circuitry to:
generate the one or more uplink transmissions using the first unified TCI state and the second unified TCI state.

3. The one or more non-transitory, computer-readable media of claim 2, wherein both the first unified TCI state and the second unified TCI state are joint unified TCI states.

4. The one or more non-transitory, computer-readable media of claim 2, wherein both the first unified TCI state and the second unified TCI state are uplink unified TCI states.

5. The one or more non-transitory, computer-readable media of claim 2, wherein the first unified TCI state is a joint unified TCI state and the second TCI state is an uplink unified TCI state.

6. The one or more non-transitory, computer-readable media of claim 1, wherein the one or more stored TCI lists comprise: a downlink or joint TCI state list that corresponds to both a first TRP and a second TRP: a downlink or joint TCI state list and an uplink TCI state list that corresponds to both a first TRP and a second TRP: or a first downlink or joint TCI state list that corresponds to a first TRP, a second downlink or joint TCI state list that corresponds to a second TRP, and an uplink TCI state list that corresponds to the second TRP.

7. The one or more non-transitory, computer-readable media of claim 1, wherein the DCI is to schedule one or more physical uplink shared channel (PUSCH) transmissions, and the instructions, when executed, further cause the processing circuitry to:
receive a mode indicator that indicates an uplink operating mode; and
generate the one or more PUSCH transmissions using the uplink operating mode,
wherein the uplink operating mode comprises:
a single-TRP UL operating mode in which the UE uses the first unified TCI state;
a single-TRP UL operating mode in which the UE uses the second unified TCI state;
a multi-TRP UL operating mode in which the UE uses the first unified TCI state for a first transmission of the one or more PUSCH transmissions and the second unified TCI state for a second transmission of the one or more PUSCH transmissions: or
a multi-TRP UL operating mode in which the UE uses the second unified TCI state for a first transmission of the one or more PUSCH transmissions and the first unified TCI state for a second transmission of the one or more PUSCH transmissions.

8. The one or more non-transitory, computer-readable media of claim 7, wherein the instructions, when executed, further cause the processing circuitry to:
receive the mode indicator as one or two bits in radio resource control (RRC) signaling.

9. The one or more non-transitory, computer-readable media of claim 7, wherein the DCI is scheduling DCI and the instructions, when executed, further cause the processing circuitry to:
receive the mode indicator as two bits in a sounding reference signal (SRS) set indicator of the scheduling DCI.

10. The one or more non-transitory, computer-readable media of claim 9, wherein the instructions, when executed, further cause the processing circuitry to:
operate in the uplink operating mode: to transmit the one or more PUSCH transmissions; until receipt of an updated uplink operating mode: or from a predetermined period of time from receiving the mode indicator.

11. The one or more non-transitory, computer-readable media of claim 7, wherein the one or more PUSCH transmission comprises a dynamic grant (DG) PUSCH transmission or a configured grant (CG) PUSCH transmission.

12. The one or more non-transitory, computer-readable media of claim 11, wherein the one or more PUSCH transmissions comprises a CG PUSCH transmission and the instructions, when executed, further cause the processing circuitry to:
receive a configuration parameter that includes one or more uplink operating modes, the one or more uplink operating modes to include the uplink operating mode,
wherein:
the CG PUSCH transmission is a type 1 CG PUSCH transmission and the configuration parameter is within a configured grant configuration (ConfiguredGrantConfig) information element to provide the mode indicator; or
the CG PUSCH transmission is a type 2 CG PUSCH transmission, the configuration parameter is indicated by a field in downlink control information (DCI) that activates the type 2 CG PUSCH transmission and includes the mode indicator.

13. An apparatus comprising:
processing circuitry configured to:
indicate, to a user equipment (UE), a first unified transmission configuration indicator (TCI) state and a second unified TCI state for a multiple-transmit-receive point (TRP) uplink operation;
generate, for transmission to the UE, a mode indicator to indicate an uplink operating mode; and
generate, for transmission to the UE, downlink control information (DCI), a media access control (MAC) control element (CE), or radio resource control (RRC) signaling to schedule one or more physical uplink control channel (PUCCH) transmissions to be transmitted using the uplink operating mode; and
interface circuitry coupled with the processing circuitry, the interface circuitry to communicatively couple the processing circuitry to a component of a device.

14. The apparatus of claim 13, wherein the uplink operating mode comprises:
a single-TRP UL operating mode in which the UE is to use the first unified TCI state for the PUCCH transmission;
a single-TRP UL operating mode in which the UE is to use the second unified TCI state for the one or more PUCCH transmissions: or
a multi-TRP UL operating mode in which the UE is to use both the first unified TCI state and the second unified TCI state for the one or more PUCCH transmissions.

15. The apparatus of claim 13, wherein the processing circuitry is further configured to:
generate, for transmission to the UE, a PUCCH resource configuration for the one or more PUCCH transmissions, the PUCCH resource configuration having the mode indicator.

16. The apparatus of claim 13, wherein the processing circuitry is further configured to:
generate, for transmission to the UE, downlink control information (DCI) with the mode indicator as two bits in a sounding reference signal (SRS) set indicator field.

17. The apparatus of claim 13, wherein the processing circuitry is further configured to:
generate a radio resource control (RRC) configuration, to be transmitted to the UE, having one or two bits as the mode indicator.

18. A method comprising:
indicating, to a user equipment (UE), a first unified transmission configuration indicator (TCI) state and a second unified TCI state for a multiple-transmit-receive point (TRP) uplink operation;
transmitting, to the UE, a mode indicator to indicate an uplink operating mode; and
transmitting, to the UE, sounding reference signal (SRS) configuration to configure an SRS to be transmitted using the uplink operating mode.

19. The method of claim 18, wherein the uplink operating mode comprises:
a single-TRP UL operating mode in which the UE is to use the first unified TCI state for the SRS; or
a single-TRP UL operating mode in which the UE is to use the second unified TCI state for the SRS.

20. The method of claim 18, wherein the SRS configuration includes the mode indicator.
